(19) United States
(12) Patent Application Publication
(10) Pub. No.: US 2005/0254785 A1
(43) Pub. Date: Nov. 17, 2005

(54) Optical disk device

(75) Inventor: Yousuke Nanba, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/126,347

(22) Filed: May 11, 2005

(30) Foreign Application Priority Data
May 12, 2004 (JP) P2004-142594

(51) Int. Cl. H04N 5/781

(52) U.S. Cl. 386/69; 386/70

(57) ABSTRACT

When a skip mode is initiated, a back end MCU employs a fast forward function to perform fast forward reproduction for a period of twenty-four seconds, for example, that is shorter than a skipping period of thirty seconds, for example, and thereafter, a time search function searches for a reproduced image at a location thirty seconds ahead. Thereafter, the skip mode is shifted to the normal reproduction mode.

### BACKGROUND OF THE INVENTION

1. Field of the Invention

The present invention relates to an optical disk device having a skip function for skipping reproduced images for a specified period of time during the reproduction of information recorded on a recording medium.

2. Description of the Related Art

The widespread use of optical disk devices, such as DVDs, for handling recording media has rapidly become an actuality.

In addition to the audio and video data that are recorded on such optical disks, which includes DVDs, address data, for data recording locations (track positions), are also recorded and are used for random access searches. Included with the address data made available for such searches are time address data, which provide the total time that has elapsed following the initiation, at a start position, of the recording of video data.

In this case, provided for an optical disk device is a time search function that employs the time address data to detect a recording position, corresponding to the total input time, on the optical disk and that starts the reproduction of the data on the optical disk at the detected location. Furthermore, just as for a video cassette recorder, a fast forward function and a fast reverse function are provided for an optical disk device.

Thus, when an optical disk device is employed for the reproduction and viewing of a digital broadcast program recorded on a DVD, for example, a user tends to use a commercial skipping function to skip commercials. In this case, the time search function is generally employed as the commercial skipping function, and reproduced images are skipped in accordance with a commercial skipping destination time, such as thirty seconds, whereafter normal reproduction is resumed. Either this, or the fast forward function is employed to skip reproduced images in accordance with a commercial skipping destination time, such as thirty seconds, whereafter normal reproduction is resumed.

That is, conventionally, either a time search function or a fast forward function is employed to skip commercials (see, for example, JP-A-2000-257160 and JP-A-2002-369128).

Fast forward reproduction for an optical disk device is performed as follows.

Since unlike a video cassette recorder an optical disk device does not linearly perform fast forward reproduction, the pre-reading of image data for a specific time ahead is required.

Various double-speed fast forward reproductions, such as four-speed, eight-speed, sixteen-speed, twenty-four-speed and thirty-six-speed, are available, but in this case, only eight-speed reproduction will be explained.

For an optical disk device, as is shown in FIG. 2A, image data An are pre-read for a specific time ahead and are temporarily stored in memory. When eight-speed reproduction is to be performed in such a pre-read state, image data A0 at the location for 0 seconds, image data A8 at the location for eight seconds, image data Al6 at the location for sixteen seconds, image data A24 at the location for twenty-four seconds and image data A32 at the location for thirty-two seconds are coupled together to generate a single stream of data (see FIG. 2B), and the data in this stream are sequentially reproduced. In this fashion, eight-speed reproduction is performed.

Therefore, when eight-speed reproduction is being performed during commercial skipping, the length of time the fast forward reproduction process is performed is greater than the thirty seconds constituting a target skip period, i.e., thirty two seconds, and since then the process is shifted to the reproduction operation, the skipping of the image can not be performed in accordance with an exact target time (thirty seconds ahead). For example, assume that a user employs a remote controller and turns off scanning to cancel fast forward reproduction while the image data A24 at the location for twenty-four seconds are being reproduced. In this case, since the five sets of image data A0, A8, A16, A24 and A32 are used to generate a single stream of data, the operation can not be shifted to normal reproduction unless the image data A32 at the location for thirty-two seconds have been reproduced.

Further, when after the image data A32 at the location for thirty-two seconds have been reproduced a scan off command is issued while a CPU that controls the entire device is currently performing another process, the scan off command can not immediately be coped with, and as a result, the distance the halt position for commercial skipping is shifted will be increased.

On the other hand, since the time search function can be used to obtain an exact time for commercial skipping, the skipping of an image in accordance with a commercial skipping designation time, such as thirty seconds ahead, can be precisely performed, and the operation can then be shifted to normal reproduction. However, when using the time search function, since during skipping no images are displayed, a user can not visually confirm that a commercial has been skipped correctly.

### SUMMARY OF THE INVENTION

To resolve these problems, the objective of the present invention is to provide an optical disk device that performs a skip operation for skipping commercials while displaying images using fast forward reproduction, as does a video cassette recorder, and that halts a skip operation at an exact skipping destination, a specified time ahead, and shifts from the skip operation to a normal reproduction operation.

To achieve this objective, according to the invention, an optical disk device includes: a skip function for skipping reproduced images a specified period time during the reproduction of information recorded on a recording medium, wherein the skip function includes a fast forward function and a time search function. Specifically, when a skip mode is initiated, the fast forward function performs fast forward reproduction for a shorter predetermined period of time (e.g., twenty-four seconds) than the specified period of time (e.g., thirty seconds), and thereafter, the time search function searches for a reproduced image located the specified period ahead (thirty seconds) and shifts from the skip mode to a normal reproduction mode.

With this arrangement, a user can confirm the skip condition, in the skip mode, while reproduced images are skipped using fast forward reproduction, and can change from the fast forward function to the time search function once the end of the specified period, which corresponds to the skipping destination, is reached, so that a rapid and accurate search can be made for a reproduced image located the specified period of time ahead. Therefore, a normally reproduced image can be viewed that begins exactly at the skipping destination.

A cancel key for canceling the fast forward function can also be provided, so that a user, by pressing the cancel key during fast forward reproduction performed using the fast forward function, can change from the fast forward function to the time search function. Further, with this arrangement, should a user desire to cancel the skip mode using the fast forward function and to quickly skip images to the next reproduction start position, the user would merely have to press the cancel key on the remote controller to change from the fast forward reproduction operation to the time search operation. Thus, images preceding the next reproduction start position could be accurately and quickly skipped.

Further, according to the invention, there is provided a skipping method for an optical disk device having a skip function for skipping reproduced images for a specified period of time during the reproduction of information recorded on a recording medium, the skipping method including the steps of, fast-forwarding a reproduction for a predetermined period of time that is shorter than the specified period of time, and time-searching for a reproduced image located the specified period of time ahead, wherein the step of fast-forwarding is executed in advance of the step of time-searching.

According to the optical disk device of the invention, the skip function can be obtained by using the fast forward function and the time search function. Further, when the skip mode is initiated, the fast forward function performs fast forward reproduction for a predetermined period of time that is shorter than a specified period of time, and thereafter, the time search function searches ahead, for a reproduced image at a location corresponding to the specified period of time, and the mode is shifted from the skipmode to the normal reproduction mode. Therefore, in the skip mode, a user can confirm the skipping state while viewing the reproduced images that are skipped during fast forward reproduction, and can exactly and quickly search ahead for the reproduced image at the location corresponding to the specified period of time. As a result, the user can resume the viewing of reproduced images beginning with the one exactly at the skipping destination.

Further, according to the optical disk device of the invention, since the cancel key is provided for canceling the fast forward function in the skip mode, when a user desires to cancel the skip mode for fast forward reproduction, and to quickly skip images to the next reproduction start position, the user need only press the cancel key of the remote controller. Then, the skipping of images, to the next reproduction start position, can be performed exactly and quickly.

Besides, the skip mode means a mode that a skipping operation is executed, and the normal reproduction mode means a mode that usual reproduction that is not the double-speed fast forward reproductions is executed,

### BRIEF DESCRIPTION OF THE DRAWINGS

These and other objects and advantages of this invention will become more fully apparent from the following detailed description taken with the accompanying drawings in which:

FIG. 1 is a circuit block diagram showing a DVD recorder that is an optical disk device according to one embodiment of the present invention; and

FIGS. 2A to 2C are diagrams for explaining a fast forward reproduction process.

### DETAILED DESCRIPTION OF THE PREFERRED EMBODIMENTS

One embodiment of the present invention will now be described while referring to the drawings.

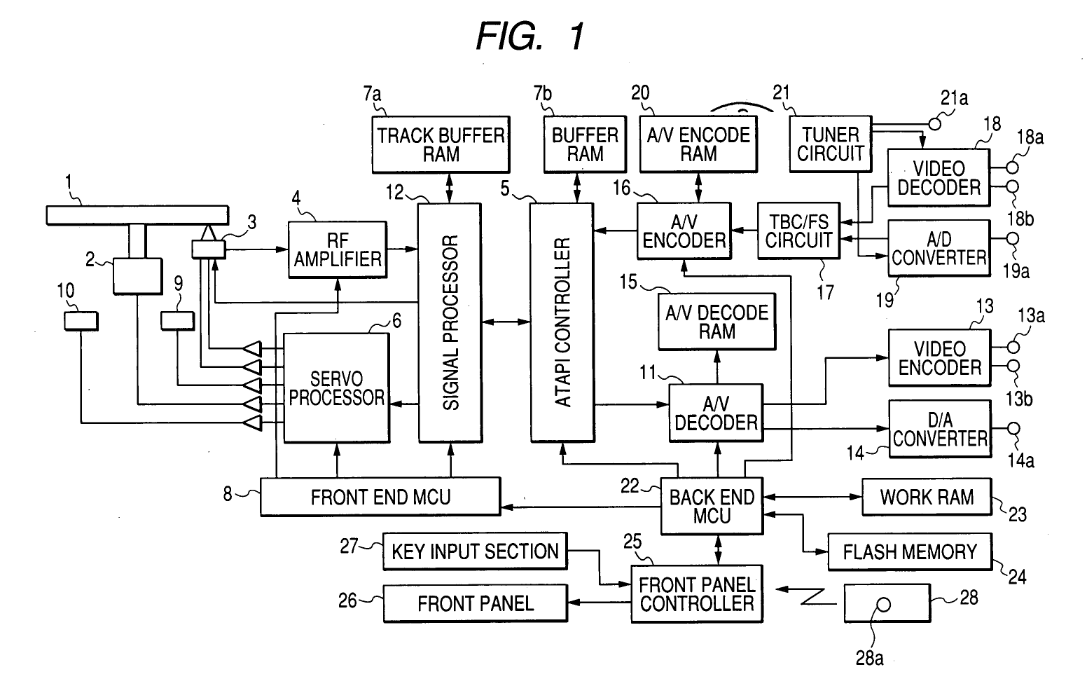

FIG. 1 is a circuit block diagram showing a DVD recorder constituting an optical disk device according to the embodiment of the present invention.

In FIG. 1, an optical pickup 3 detects information on an optical disk 1 rotated by a disk motor 2, and outputs the information, via an RF amplifier 4, to an ATAPI controller 5 and a signal processor 12. A track buffer RAM (e.g., an SDRAM) 7a, which is connected to the signal processor 12, is used to temporarily store data that are amplified by the RF amplifier 4 and decoded in accordance with a DVD standard (in this embodiment, data are compressed using the MPEG (Moving Picture Experts Group) standard). The RF amplifier 4 and the signal processor 12 are controlled by a front end MCU 8.

In accordance with a command, and control data exchanged with the front end MCU 8 via the signal processor 12, a servo processor 6 provides servo control, such as for focusing servo and tracking servo, for the optical pickup 3 and also controls a thread motor 9, which moves the entire optical pickup 3 in the radial direction of the optical disk 1, and a tray motor 10, which drives a tray (not shown) on which an optical disk 1 is mounted.

The signal processor 12 is connected to an A/V (Audio/Video) decoder 11 via the ATAPI controller 5, to which a buffer RAM 7b is connected, and the output terminal of the A/V decoder 11 is connected to a video encoder 13, having video output terminals 13a and 13b, and a D/A converter 14, having an audio output terminal 14a. The A/V decoder 11 expands MPEG compressed data that are read from the track buffer RAM 7a. Furthermore, connected to the A/V decoder 11 is an A/V decode RAM (e.g., an SDRAM) 15, for storing decompressed digital data for several screens.

The output terminal of the video decoder 18, for which video input terminals 18a and 18b are provided, and the output terminal of an A/V converter 16, which has an audio input terminal 19a, are connected to an A/V encoder 16 via a TBC/FS (Time Base Corrector/Frame Synchronizer) circuit 17, and the output terminal of the A/V encoder 16 is connected to the signal processor 12 via the ATAPI controller 5. The signals output by a tuner circuit 21, which has an antenna terminal 21a, are transmitted to the video decoder 18 and the A/D converter 19. The A/V encoder 16 uses MPEG to compress data stored in the A/V encode RAM 20, and outputs the compressed data to the ATAPI controller 5.

The ATAPI controller 5, the A/V decoder 11 and the A/V encoder 16 are connected to a back end MCU 22, to which a work RAM 23 and a flash memory 24 are also connected.

Further, a front panel controller 25, for controlling the display on a front panel 26 such as an LCD, is connected to the back end MCU 22, and a signal output by a key input section 27 is transmitted to the front panel controller 25. A receiver (not shown), for receiving a signal from a remote controller 28, is provided for the front panel controller 25, and a cancel key 28a that will be described later, for canceling a fast forward function during a skip mode, is provided for the remote controller 28.

Besides, the skip mode means a mode that a skipping operation is executed, and a normal reproduction mode means a mode that usual reproduction that is not the double-speed fast forward reproductions is executed.

The reproduction operation performed by the thus arranged DVD recorder will now be explained.

Upon receiving a reading instruction from the back end MCU 22, the front end MCU 8 controls the optical pickup 3 via the servo processor 6. Then, data recorded on the optical disk 1 are detected by the optical pickup 3, and the waveform of the data is shaped and the data are amplified by the RF amplifier 4. Subsequently, the resultant data are sequentially transmitted, via the signal processor 12, and stored in the buffer RAM 7b of the ATAPI controller 5.

The data in the buffer RAM 7b are transferred to the A/V decoder 11, whereat MPEG compressed data are decompressed and decoded to obtain video data. The thus obtained video data are temporarily stored in the A/V decode RAM 15, and are then read again and sequentially transferred to the video encoder 13. Following this, the video data are converted into analog video signals that are output, via the video output terminals 13a and 13b, to the monitor screen of a television receiver (not shown).

In addition to video data, audio data from the buffer RAM 7b are transmitted to the A/V decoder 11 and temporarily stored in the A/V decode RAM 15, and thereafter, are read again and transmitted to the D/A converter 14. Then, the audio data are converted into analog audio signals that are output, by the audio output terminals 14a, via a built-in microphone provided for the television receiver (not shown).

Provided for the optical disk device of the invention is a skip function that, during the reproduction operation, skips reproduced images for a specified period of time. This skip function is controlled by the back end MCU 22, and in this embodiment, is provided by using the fast forward function and the time search function. The skip function will be specifically explained later.

Assume that a period (a specified period) allocated for skipping images during a single skip operation is thirty seconds, and assume that a commercial skipping function is employed for skipping commercial portions during the reproduction of information on the optical disk 1. When the commercial skipping is started, the back end MCU 22 performs fast forward reproduction for a shorter period (e.g., twenty-four seconds) than the thirty seconds allocated for the specified period of time, and thereafter, the time search function searches for a reproduced image located thirty seconds ahead, which corresponds to a skipping destination, and the operating mode is shifted to the normal reproduction mode. In the following example, eight-speed reproduction is employed as the fast forward reproduction speed for the fast forward function.

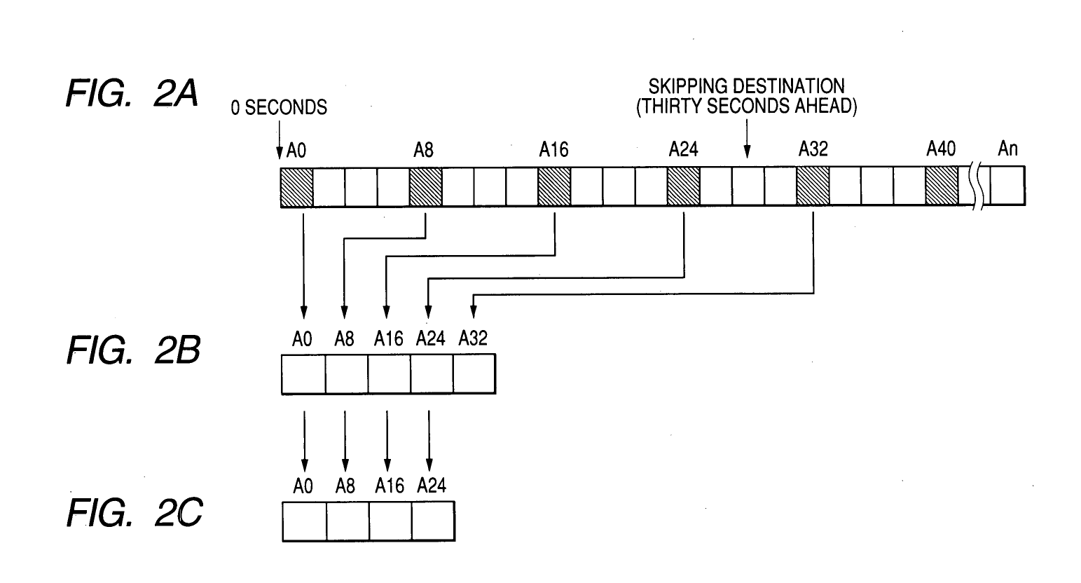

As described in the sub-division [Means For Solving The Problems], and as is shown in FIG. 2A, during reproduction the optical disk device pre-reads reproduced image data and temporarily stores them in the A/V decode RAM 15. In this pre-read state, when eight-speed fast forward reproduction using commercial skipping is to be performed, the image data A0 at the location corresponding to 0 seconds, the image data A8 at the location corresponding to eight seconds, the image data A16 at the location corresponding to sixteen seconds and the image data A24 at the location corresponding to twenty-four seconds are coupled together, generating a single stream of data (see FIG. 2C), and the image data are sequentially reproduced. In this fashion, eight-speed reproduction is performed.

Specifically, when the skip mode has been initiated, image data, including the image data A0, the image data A8, the image data A16 and the image data A24, are intermittently reproduced and displayed using fast forward reproduction, and when reproduction of the image data A24 has been completed, the fast forward function is changed to the time search function. Then, the time search function searches for a reproduced image at a commercial skipping target position thirty seconds ahead of the twenty-four second location. Thereafter, the skip mode is shifted to the normal reproduction mode, and as a result, the user can identify the skip state, while viewing images intermittently reproduced by the fast forward function, and can correctly and quickly search for a reproduced image at a location a specified period ahead of that for the skipping destination. As a result, the user can again view a reproduced image beginning at an exact skip position.

In addition to the commercial skipping function, in this embodiment, the cancel key 28a, for canceling the fast forward mode, is provided for the remote controller 28.

That is, when the user manipulates the cancel key 28a while fast forward reproduction is being performed by the fast forward function, the signal from the cancel key 28a is transmitted via the front panel controller 25 to the back end MCU 22. Upon receiving this signal, the back end MCU 22 changes the commercial skipping process from the fast forward mode to the time search mode.

When the user manipulates the cancel key 28a while viewing the image data A16 at the sixteen second location during fast forward reproduction, based on this signal, the back end MCU 22 employs the time search function to find a reproduced image at a skipping destination thirty seconds ahead of the location for image data A16 (location for sixteen seconds), and performs normal reproduction beginning at the reproduced image at the thirty second location. As is described above, when a user desires to cancel fast forward reproduction and to quickly skip images up to the skipping destination, the user need only press the cancel key 28a of the remote controller 28 to shift from the fast forward function to the time search function. Therefore, images preceding the next reproduction start position can be skipped exactly and quickly.

In this embodiment, the commercial skipping operation has been explained as an example. However, naturally, the skip function of this invention can be employed in a case wherein the skip mode is performed when a user manipulates the skip key (not shown) of the remote controller 28 while watching a reproduced image.

### FIG. 1

4; RF AMPLIFIER
5: ATAPI CONTROLLER
6: SERVO PROCESSOR
7a: TRACK SUFFER RAM
7b: BUFFER RAM
8: FRONT END MCU
11: A/V DECODER
12: SIGNAL PROCESSOR
13: VIDEO ENCODER
14: D/A CONVERTER
15: A/V DECODE RAM
16: A/V ENCODER
17: TBC/FS CIRCUIT
18: VIDEO DECODER
19: A/D CONVERTER
20: A/V ENCODE RAM
21: TUNER CIRCUIT
22: BACK END MCU
23: WORK RAM
24: FLASH MEMORY
25: FRONT PANEL CONTROLLER
26: FRONT PANEL
27: KEY INPUT SECTION

1. An optical disk device comprising:
a back end micro controller unit for controlling a skip function for skipping reproduced images for a specified period of time during the reproduction of information recorded on a recording medium;
a front end micro controller unit for receiving a reading instruction from the back end micro controller unit, and for controlling an optical pickup; and
a cancel key, wherein:
the skip function includes a fast forward function and a time search function;
when a skip mode is initiated, the fast forward function performs fast forward reproduction for a predetermined period of time that is shorter than the specified period of time, and thereafter the time search function searches for a reproduced image located the specified period of time ahead and shifts from the skip mode to a normal reproduction mode; and
when a user presses the cancel key during fast forward reproduction using the fast forward function, the back end micro controller unit changes the function from the fast forward function to the time search function.

2. An optical disk device comprising:
a back end micro controller unit for controlling a skip function for skipping reproduced images for a specified period of time during the reproduction of information recorded on a recording medium; and
a front end micro controller unit for receiving a reading instruction from the back end micro controller unit, and for controlling an optical pickup, wherein
the skip function includes a fast forward function and a time search function.

3. The optical disk device according to claim 2, wherein
when a skip mode is initiated, the fast forward function performs fast forward reproduction for a predetermined period of time that is shorter than the specified period of time, and thereafter the time search function searches for a reproduced image located the specified period of time ahead, and shifts from the skip mode to a normal reproduction mode.

4. A skipping method for an optical disk device having a skip function for skipping reproduced images for a specified period of time during the reproduction of information recorded on a recording medium, the skipping method comprising the steps of:
fast-forwarding a reproduction for a predetermined period of time that is shorter than the specified period of time; and
time-searching for a reproduced image located the specified period of time ahead, wherein
the step of fast-forwarding is executed in advance of the step of time-searching.
